(19) United States
(12) Patent Application Publication
(10) Pub. No.: US 2015/0272018 A1
(43) Pub. Date: Oct. 1, 2015

(54) OFFSHORE AQUACULTURE INSTALLATION

(71) Applicant: Serge MENARD, Saint Julien de Gras Capou (FR)

(72) Inventor: Serge Menard, Saint Julien De Gras Capou (FR)

(21) Appl. No.: 14/436,333

(22) PCT Filed: Oct. 17, 2013
(86) PCT No.: PCT/EP2013/003129

§ 371 Date: Apr. 16, 2015

(30) Foreign Application Priority Data
Oct. 17, 2012 (FR) 1202781
Oct. 18, 2012 (FR) 1202802

(51) Int. Cl. A01G 31/02; A01K 75/00; A01K 71/00; A01K 61/00; A01K 63/00

(52) U.S. Cl. CPC A01G 31/02; A01K 61/007; A01K 63/003; A01K 63/006; A01K 71/00; A01K 75/00

(57) ABSTRACT

The aim of the present invention is to propose an offshore aquaculture installation in a healthy environment for fish, having the smallest possible impact on the environment in terms of pollution, with a combination of technical means ensuring the stability of the structure and the safety of humans, with all the equipment necessary for easy offshore operation. This aim achieved by an offshore aquaculture installation comprising one or a plurality of cages (1) for breeding fish and a floating structure (2) that is ballasted and submersible. The installation is characterised in that it comprises a main anchoring device having an anchor line (3) linked on one side (6) of the structure (2) and capable of being anchored on the other side to a single anchoring point (4) in the installation environment, the structure comprising at least two parallel casings (5) containing adjustable ballasts, said casings (5) being in installed at the bottom of each of the lateral face (7) of the structure (2), in that the cage or cages (1) is/are square or rectangular, and in that the upper portion of the installation constitutes a handling bridge providing access to the cages.

The present invention relates to an offshore aquaculture installation,

Intensive fish breeding in a dosed environment tends to develop largely nowadays. For this purpose, numerous wire cages have been created where fish can be fed up somehow, be kept away from predators, be monitored for their health condition, and then be caught easily when they have reached the desired size.

Aquaculture facilities placed in protected sites such as atolls or fjord grounds are already known. However, a shortcoming of these facilities is their containment since water is only partially renewed and undergoes different pollution processes. Thus, fish cause local pollution of the volume containing them, as well as pollution of the submarine space situated under the installation, which also reduces the quantity of oxygen available in the breeding volume. This situation promotes the development of diseases to the extent that the density of fish in the cages must be limited. This makes it compelling to use a large operation surface to achieve the targeted production. However, this large surface area will also be polluted. Moreover, these facilities can be polluted by continental refuse, such as for instance nitrates, city wastewater, etc.

These coastal facilities have also other shortcomings. They pollute the coastal zones which provide the favored wild fish spawning areas, which jeopardizes the future production of professional fishing, which is already declining.

Moreover, these coastal facilities are now competing with the development of real estate promotion, water sports, yachting, tourism and other shoreline activities.

Offshore aquaculture has tried to remedy these shortcomings. To achieve this, floating cages anchored at the bottom of the sea have been used. The operation of said cages is more satisfactory when they are in storm-protected bays or coves. However, pollution remains a recurrent problem, since the absence of marine currents does not enable sufficient dispersion of the rejections from breeding cages, which also compels to reduce the density of fish in the cages. Moreover, these artisanal cages cannot resist the conditions prevailing offshore and are also exposed to the pollutions rejected by the continent.

Most recently, offshore facilities have come to light. These facilities are ballasted and submersible and can evade storms and surface dangers, they can be arranged in areas traversed by marine currents and include several spaced-apart breeding modules, and positioned across the current.

They are held in position by anchoring lines fitted with line tension adjustment devices to adapt to tidal ranges. The variation in water height can reach 12 meters. These anchoring lines are connected most often to mooring structures that must be positioned carefully, which requires telemetry studies and often very costly geotechnical arrangements, since the stability of the installation depends on the accuracy of these adjustments, whereas the undefined form of these ballasted facilities does not enable to secure the indispensable stability of the plant alone.

When the conditions of the currents are well-suited, i.e. when the currents are sufficiently strong to enable good dispersion of the breeding rejections and maintain good oxygenation of the volume of water used, these facilities can give satisfaction on the breeding level.

However, in seas where the currents have a low to average intensity, pollution becomes possible again, with the consequences already mentioned.

The aim of the present invention is to provide an offshore aquaculture installation in a healthy environment for fish with the smallest possible footprint on the environment in terms of pollution, with a combination of technical means securing the stability of the structure and the safety of men, with all the necessary pieces of equipment enabling easy offshore operation.

According to the invention, this object is met by an offshore aquaculture installation comprising one or several cages for breeding of fish and a floating, ballasted and submersible structure. The installation is characterized in that it comprises a main anchoring device with an anchoring line connected on the one side to the structure and enabling on the other side to be anchored on a single anchoring point in the environment of the installation. The structure comprises at least two parallel hulls containing adjustable ballasts, whereas these hulls are installed at the bottom of each of the side faces of the structure. The installation comprises one or several square or rectangular cages and its upper portion forms a handling bridge enabling circulation on the plant and securing access to the cages and to the operation equipment which might be provided.

The object of the invention is partially achieved by making the installation mobile thanks to a single main anchoring line enabling to carry out a large scope gyratory movement, thereby multiplying at least by 5, advantageously by 10, and more advantageously by 20 or more, the operation surface of the installation. The stability of the structure is ensured thanks to the hulls situated at the bottom of each of the lateral faces of the structure, which are less sensitive to surface sea movements. The keels enable better orientation of the installation with respect to a water current. If the direction of the water current changes, the installation may move thanks to its single anchoring line, while keeping its orientation relative to the current. This arrangement also contributes to the stability of the installation. Thus, the direction of the water current inside the structure is known and the efficiency of the installation can be improved, for instance by the layout of the cages, of the food distribution points etc For example, the loss of food through water currents can be strongly limited by providing the food upstream.

It goes without saying that the main anchoring line enables the orientation of the installation according to the currents. However, one or several secondary anchoring lines can be installed for example to secure the plant in case of failure of the main anchoring line, without affecting under normal conditions the orientation function of the main anchoring line.

The structure is easily accessible, even under unfavorable weather conditions, if the upper portion of the plant comprises an even working surface, such as a handling and circulation bridge securing access to the cages and to the operating equipment provided. The surface area of this bridge may be in particular at least of 500 m², advantageously 1000 m², and possibly even 2000 m² or more. its length may reach 60 m or more. This layout and its dimensions enable to carry out an efficient operation, with a minimum of risks for the staff. Moreover, the bridge of the installation can be elevated above the level of the waves thanks to the ballasts of the installation; thereby the installation can float at different levels to suit the needs and the condition of the sea.

To improve the stability of the structure, the hulls of the structure can be fitted with fixed or mobile keels. The keel of a boat designates the lowermost part of the boat. It enables to keep the boat balanced and also serves as a skeg. The word keel in the context of this document designates the form of a hydrodynamic body which enables the alignment of the structure with respect to a water current. Thus, the hulls may have flattened horizontal and/or vertical surfaces giving them the advantages of a keel by contributing to reducing the roll or pitch movements.

Fitting the hulls with keels enables faster orientation of the installation during changes of currents and better stability if the sea is rough.

Advantageously, the hulls can be fitted with roll stabilizers.

The form and the layout of the hulls at the bottom of each of the side faces of the structure is an application of the SWATH (Small Waterplane Area Twin Hull) concept of a boat with two hulls A boat with SWATH hulls is a twin hull boat, each hull being deeply immersed. The central platform at the water line level is connected to the hulls through thin junctions. This layout improves seaworthiness in bad weather.

Depending on the dimensions of the installation, it may be advisable to position the hulls even deeper in the water to avoid sometimes rough areas dose to the surface. For this purpose, thin and substantially vertical junction elements can be provided, connecting the hulls to the installation. The hulls can thus be arranged below the plant and secure in such a case, thanks to their position, their form and their volume, better hydrostatic and hydrodynamic stability of the plant, which makes the plant particularly stable and insensitive to the destabilizing effects of the waves.

The advantages of the invention also enable on site implantation without costly adjustments and easy, fast and very economically displacement of the plant, with the possibility of moving the plant at any pollution alert of the operation surface occupied.

An anchor point of such a facility can for instance be a ballasted mooring structure with a fastening device for the anchoring line of the installation. This can also be any anchoring device such as a suction anchor, a buried stem or column, or any device fulfilling simultaneously the anchoring function and allowing a circular rotation. Anchoring on a single anchoring point has several advantages. First of all, the plant may perform a complete rotation over 360° on the horizontal plane, for example thanks to a rotary support connecting the anchoring line to the mooring structure, to prevent the anchoring line from being twisted, which might otherwise weaken it. The position of the installation is auto-adjusted according to the direction of the prevailing marine currents. The possible rejections of the plant are then easily dispersed.

Moreover, this single and ballasted mooring structure enables to install and to move the whole installation within quite a short time, which may also enable to change locations in case of insufficient currents or of any alert of self-pollution, for total preservation of the quality of the marine environment and maximum oxygenation of the breeding volume.

The length of the anchoring line has been calculated to establish a distance between the plumb line of the anchoring point and the linking point of the anchoring line to the installation of at least 25 m, advantageously 50 m, or 80 m and more. These characteristics enable the installation to scatter its possible rejections along a significant circular perimeter, with a length proportional to its radius, whereas the permanent positioning of the longitudinal axis of the plant in the axis of the prevailing current providing better stability as well as notable advantages for easier operation.

Advantageously, the anchoring line is a rigid or semi-rigid arm. The connection between the anchoring line and the structure on the one hand and between the anchoring line and the anchoring point on the other hand can be a hinged connection on the horizontal plane, so as to compensate for the possible pitch of the plant and the different water levels caused by tides. If the arm is a rigid arm, the plant can move along the periphery of a circle defined by the length of the arm which represents its radius. The arm can also be semi-rigid to enable free displacement of the plant around the periphery of a circle without the installation being able to traverse the inside of the circle.

In another embodiment, the anchoring line is formed of several anchoring lines or of triangulated arms positioned in such a way that the ends connected to the installation can be spaced apart over the whole or a portion only of the width of the facility, whereas the opposite ends join at a central arm rather close to the central anchoring point or on the central anchoring point. These triangulated arms can be strengthened by reinforcements connecting them.

If the arm is rigid and non-hinged, the installation is always in a substantially radial position with respect to the circle defined by the arm. The arm may preferably be hinged in a vertical direction close to its anchor points or at the level of its anchoring points to adapt to the sea condition and to the currents. The arm can also be telescopic to keep a constant but adjustable anchoring radius length, regardless of the condition of the sea and currents.

The elements mentioned above and the fact the upper portion of the installation can be in normal operation condition 2 or 3 meters or more above sea level, facilitate the operation of the installation, in particular by providing constant and more reassuring mooring and access conditions. The posts and the handling equipment can be grouped, for example at the back of the installation, on the side opposite of the anchoring line. This grouping of the specific operation functions limits the movement of the staff on a large-size plant which may reach 60 m and more.

The installation can in particular be elongated in shape and formed of longitudinal parallel cages, along its entire length. This arrangement enables fish to perform their longest travels into the current, which brings them closer to natural life and secures better flesh quality.

Moreover, the cages can be fitted with meshed surfaces made of copper alloy, this alloy providing major operation advantages, such as for instance protection against external pollutions, diseases and contamination, better growth of the fish, etc.

The cages can be fitted with mobile partitions, meshed or with nets for reducing the breeding volume in the longitudinal, transversal and/or vertical direction. This reduction can go down to a volume of 2 m³. These volume reductions enable to carry out fish sorting and collecting down to the last fish easily.

The installation can be fitted with a standalone control and/or surveillance module, which can be inhabitable or not, totally waterproof and submersible, integrated to the installation or removable, situated on the upper portion of the installation or forming an independent, floating and ballasted, submersible or semi-submersible module. This control module can also be an appropriately equipped boat.

The installation according to the invention may also contain, in addition to the normal meshes or nets of the cages, deploying devices of mesh nets, lattices, plankton nets or textile walls either on all or a part of the vertical and horizontal faces of its cages, or on all or a part of the external faces of the installation, so as to cover them totally or partially only. Each device can be actuated by manual winches, rewinders, cables, hinged or telescopic arms, manually or in an automated fashion, for easy intervention on the nets, lattices, plankton nets or textile walls, in particular to avoid food losses, to collect droppings or to ensure protection against external organisms, such as jellyfish for example. The size of the meshes must be selected to suit the purpose, for example smaller for collecting droppings and larger to protect against jellyfish.

The installation may moreover be fitted with a mast comprising in particular radio, radar, video and/or radio control equipment. The mast can be fixed or telescopic and/or retractable for easier maintenance of the equipment carried by the mast and the transportation or the displacement of the installation thanks to the possible reduction in height of the mast when it is telescopic or retractable. The height of such a mast could be of at least 20 m, advantageously 30 m or more. This mast which can be telescopic and/or retractable enables to bring the mast head carrying the equipment back to the level of the ‘deck’ of the installation, and men to intervene on the equipment without needing to climb up the mast. The head of mast carrying the equipment may also comprise a support for the equipment; to slide along a rigid mast. The mast may also contain a nacelle for accessing the top in complete safety.

To be autonomous, the installation can advantageously be fitted with water turbines and/or rigid, semi-rigid or flexible photovoltaic panels, whereas the latter can be actuated by reel-operated deploying devices. Besides, the installation can be fitted with wind turbines, which may in particular be retractable or also be installed on the mast of the plant.

The plant may be equipped with hollow and totally or only partially waterproof skegs, which may be weighted and/or ballasted, and situated preferably at the back, on the external part of the longitudinal faces of the installation. They can also be installed on the bridge of the installation, in which case they exert the function of a skeg only with respect to the winds or when the installation is immersed. These skegs may contain different pieces of control and/or surveillance equipment, energy storage, compressed air or food stores for instance, in addition to their dynamic function, and can comprise access means and an overhang forming an advancing for protection against the waves. These skegs can also comprise dwelling accommodations. The skegs can in particular include food containers with variable volumes. They may comprise ballasts to compensate for weight differences in food present in these containers.

The invention is explained in more detail below using the appended figures which show an embodiment of the invention schematically:

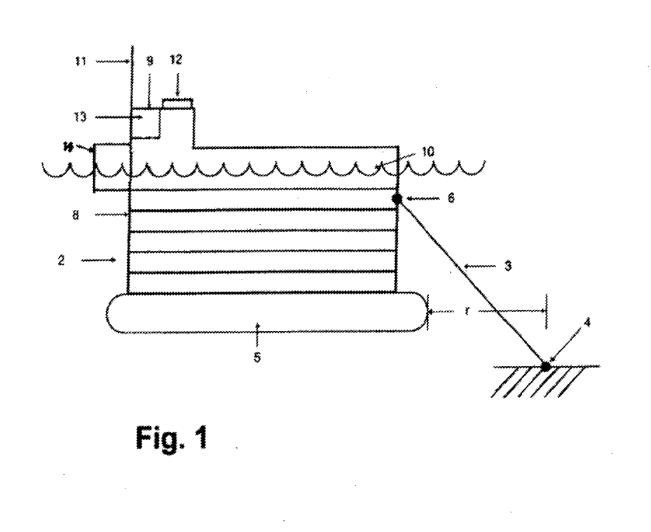

FIG. 1 shows an aquaculture installation according to the invention in a side view;

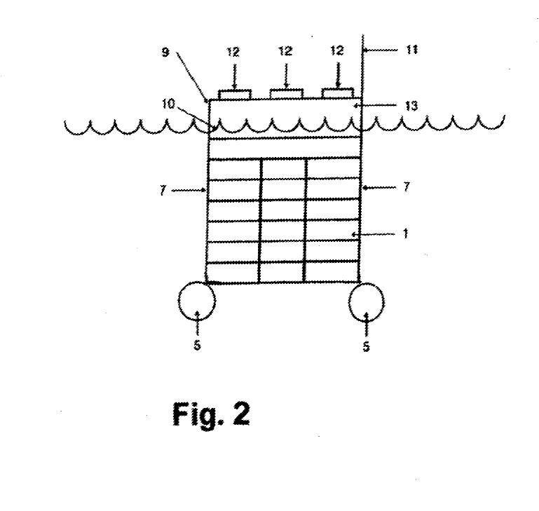

FIG. 2 shows the aquaculture installation according to FIG. 1 in a rear view;

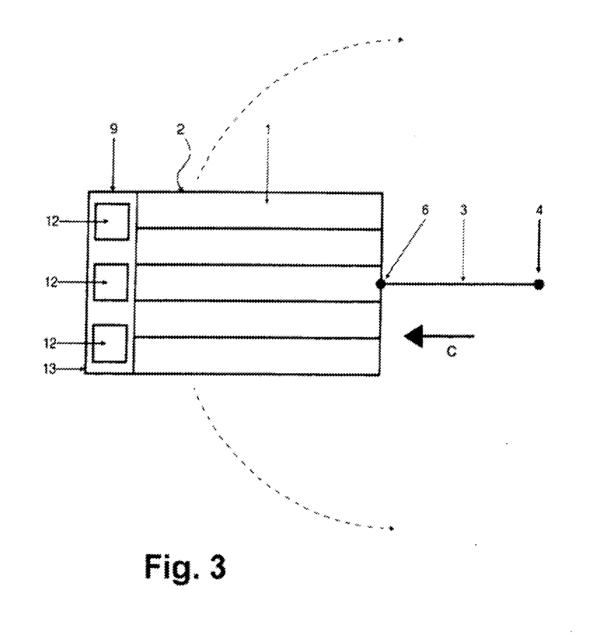

FIG. 3 shows the aquaculture installation according to FIGS. 1 and 2 in a top view.

FIG. 1 illustrates an embodiment of an aquaculture installation according to the invention in a side view. It has to be noted that this figure, as well as the other figures, show the installation purely schematically to explain the general operating mode of the invention. Figures are neither true to scale nor complete but show schematically only the elements which are necessary to appreciate the invention.

The installation contains several rectangular cages 1 for fish breeding and a ballasted and submersible floating structure 2. The plant is globally rectangular in shape. It comprises two parallel hulls 5 installed at the bottom of each of the side faces 7 and having keels. The upper portion of the part mostly exhibits a planar surface.

The plant comprises moreover an anchoring device with a rigid anchoring arm 3. The arm is linked on one side 6 to the structure 2 of the plant and is anchored on the other side on a single anchoring point 4 in the environment of the plant, in that particular instance on a ballasted dead body, installed at the bottom of the sea.

The fittings of the arm 3 on both sides 4, 6 are hinged fittings around horizontal axes so as to compensate for the effects of the tidal range. Anchoring to the single anchoring point 4 to a mooring structure enables 360° rotation of the plant on the horizontal plane. The arm 3 can be telescopic to keep the rotation radius r constant, independently from the tides.

The hulls 5 comprise adjustable ballasts so as to be able to adjust the floating level 10 of the plant or immerse it to the selected depth.

In normal operation condition, The upper portion of the plant is situated 2 to 3 meters above the sea level. The mooring and access conditions are thus more reassuring. The posts and the handling equipment 9 are grouped at the back 8 of the installation, on the side opposite the anchoring arm 3. The plant comprises a retractable mast 11 to transmit radio electric signals, photovoltaic panels 12 to make the installation autonomous, and dwelling accommodations 13 for the maintenance staff.

FIG. 2 shows the plant according to FIG. 1 in a rear view. Both hulls 5 can be seen at the bottom of the lateral sides 7 of the structure 2. The hulls 5 have keels 14. The position of the hulls 5 at the bottom of the structure is an application of the SWATH concept which makes the plant stable and insensitive to the destabilizing effects of the waves.

FIG. 3 is a top view of the plant according to FIGS. 1 and 2. The plant is rectangular in shape with an elongated rectangular base surface of 60 m of length. The anchoring arm 3 connects the plant to a single anchoring point 4 on a ballasted mooring structure at the bottom of the sea and allows the installation rotation about 360°. The length of the rigid arm 3 is selected to that the rotation radius of the plant is of the order of magnitude of 80 m.

The connection 6 of the arm 3 to the structure 2 is hinged to enable the plant to rotate with respect to the arm 3 about a horizontal axis so as to compensate for tidal effects. However, the connection 6 is otherwise rigid so that the structure 2 cannot rotate with respect to the arm 3 but solely about the single anchoring point 4. A change in the sea current at the location of the installation thus causes a displacement of the installation by rotation about the anchoring point 4. The operating surface area of the installation is thus multiplied and the possible rejections from the plant are scattered.

The cages 1 inside the structure are arranged in the longitudinal direction over the whole length of the plant. The keels provide for the automatic orientation of the plant in the direction of the currents. The orientation of the plant defined with respect to the currents exhibits several advantages. It enables for instance fish to perform their longest travels in longitudinal cages into the current C, which brings them closer to natural life and secures better flesh quality. Moreover, feed supply points can be selected upstream so as to limit losses.

1. An offshore aquaculture installation comprising
one or several cages (1) for breeding of fish and
a floating, ballasted and submersible structure (2),
characterized in that
the installation comprises a main anchoring device with an anchoring line (3) connected on the one side (6) to the structure (2) and enabling on the other side to be anchored on a single anchoring point (4) in the environment of the installation,
the structure comprises at least two parallel hulls (5) containing adjustable ballasts, whereas these hulls (5) are installed at the bottom of each of the side faces (7) of the structure (2),
the cage(s) (1) are square or rectangular, and
the upper portion of the plant forms a handling bridge securing access to the cages.

2. The aquaculture installation according to claim 1, characterized in that the hulls (5) are provided with fixed or mobile keels.

3. The aquaculture installation according to claim 1 or 2, characterized in that the anchoring line consists of a rigid or semi-rigid and/or telescopic arm (3).

4. The aquaculture installation according to any of the claims 1 to 3, characterized in that the anchoring line is a rigid or semi-rigid arm composed of several triangulated arms.

5. The aquaculture installation according to any of the claims 1 to 4, characterized in that the connection between the anchoring line and the structure and between the anchoring line and the anchoring point is a hinged connection on the horizontal plane.

6. The aquaculture installation according to any of the claims 1 to 5, characterized in that the anchoring device (3) enables a 360° rotation of the installation.

7. The aquaculture installation according to any of the claims 1 to 6, characterized in that it is elongated in shape and formed of longitudinal cages (1) along the entire length of the installation.

8. The aquaculture installation according to any of the claims 1 to 7, characterized in that the cages (1) are provided with mobile partitions.

9. The aquaculture installation according to any of the claims 1 to 8, characterized in that it comprises devices for deploying mesh nets over all or a portion of the vertical and horizontal faces of its cages and/or over all or a portion of the external faces of the plant.

10. The aquaculture installation according to any of the claims 1 to 9, characterized in that it comprises hollow and waterproof skegs (14) situated at the back (8), outside the longitudinal faces of the plant.

11. The aquaculture installation according to any of the claims 1 to 10, characterized in that the hollow skegs (14) are situated on the bridge of the plant.

12. An aquaculture installation according to claim 11, characterized in that the skegs comprise adjustable ballasts.

13. The aquaculture installation according to any of the claims 1 to 12, characterized in that it is fitted with a waterproof and submersible control and/or surveillance module, integrated to the plant or removable or forming an independent, floating and ballasted, submersible or semi-submersible module.

14. The aquaculture installation according to any of the claims 1 to 13, characterized in that it is fitted with a mast (11) comprising particular radio, radar, video and/or radio control equipment and in that said mast is fixed or telescopic and/or retractable, in particular integrated to the plant or to the control module.

15. The aquaculture installation according to any of the claims 1 to 14, characterized in that it is fitted with water turbines and/or rigid, semi-rigid or flexible photovoltaic panels (12), in particular actuated by reel-operated deploying devices.
